(19) United States
(12) Patent Application Publication
(10) Pub. No.: US 2009/0106061 A1
(43) Pub. Date: Apr. 23, 2009

(54) PROGRESSIVE VENDOR DATA MANAGEMENT AND VERIFICATION IN A MULTI-NODE SUPPLY NETWORK

(75) Inventors: Ivory W. Knipfer, Rochester, MN (US); Jason S. Lee, Oronoco, MN (US); Matthew H. Zemke, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/876,487

(22) Filed: Oct. 22, 2007

(51) Int. Cl. G06F 17/30

(52) U.S. Cl. 705/7

(57) ABSTRACT

Embodiments of the present invention address deficiencies of the art in respect to product data sharing in a multi-node supply chain and provide a method, system and computer program product for progressive vendor data management and verification in a multi-node supply chain. In one embodiment of the invention, a method for progressive vendor data management and verification in a multi-node supply chain can be provided. The method can include propagating vendor data requirements for a product component downstream from a root node in the supply chain to a leaf node in the supply chain producing a portion of the product component. The method further can include verifying vendor data at each node in the supply chain according to the vendor data requirements.

### BACKGROUND OF THE INVENTION

1. Field of the Invention

The present invention relates to the field of manufacturing activity management and more particularly to vendor data management in a multi-node supply network.

2. Description of the Related Art

As the global economy provides a proliferation of options for businesses to expand into emerging markets, manufacturing success increasingly can be defined by how fast one acts and how well one reacts to supply chain volatility. Modern production facilities increasingly are becoming more complex as customers expect manufacturers to maintain low prices while readily accommodating last-minute changes in quantity, product configuration or delivery date. Thus, effectively managing the timing, order policy, and supply and inventory considerations involved in new product introductions or upgrades, greatly impact cycle times, potential business opportunities, and most importantly sales and profits.

The supply network for a manufacturing supply chain historically involved only two tiers: a raw materials tier supplying an integration tier producing a finished good for sale to a customer. The globalization of manufacturing, however, has resulted in multi-node supply networks. In a multi-node supply network, raw materials suppliers supply intermediate component parts manufacturers who in turn supply other upstream component parts manufacturers and so forth until encountering a final assembly point for the finished good.

One of the key enablers of multi-nodal supply manufacturing, and indeed one of the most notable problems, is the management of the “product data” produced at each level through the chain to the final integrator, as well as the reverse data flow required to manage any changes back to the original suppliers. Each member within the supply chain requires product data from upstream and downstream suppliers in order to make efficient and accurate business decisions. Exemplary business decisions include warranty terms, defective part containment, asset tracking, and yield analysis. Without “product” data being available on a timely and accurate basis, however, the ability to produce products within short cycle times at a minimum cost can be compromised. Likewise, the lack of information can result in defective parts being pushed into the field and materials becoming unavailable during peak production resulting in loss of revenue and missed shipments.

At present, when an upstream node in a supply chain receives a defective or inadequate part, the part can be rejected or accepted according to the requirements of the upstream node. The requirements for components incorporated into the part of the immediate downstream node, however, remain unknown to the upstream node including instances of component rejection. In fact, the history for a component in the part can remain completely unknown to the upstream node though the downstream node can collect such data. In consequence, the lack of coordination amongst all nodes in the supply chain can omit critical data from the product knowledge of the final assembler producing the finished goods.

In the past, the electronic data interchange (EDI) medium has utilized a “mailbox” feature set in order to share component part data between different nodes in a multi-node supply network. Specifically, the mailbox feature set permits a downstream supplier to include product data in an EDI message to an upstream customer receiving a component provided by the downstream supplier. The upstream customer must poll the mailbox in order to detect the receipt of a message. Thereafter, upstream customer can translate the message to determine the product information for component and the product information can be incorporated into the product information for the assembled product.

The EDI mail box feature set, however, remains a tier-to-tier tool for sharing product information in a multi-node supply network. Critical downstream data is not shared with upstream customers. Additionally, EDI provides no error checking and no feedback loop to downstream suppliers to correct deficiencies in the product data. Of course, the receipt and detection of product data provided by a downstream supplier node to an upstream customer node in an EDI mailbox can be asynchronous to the receipt and handling of the components provided by the downstream supplier node to the upstream customer node. Accordingly, opportunities arise for out of sync data and mismatching of data to received product.

### BRIEF SUMMARY OF THE INVENTION

Embodiments of the present invention address deficiencies of the art in respect to product data sharing in a multi-node supply chain and provide a novel and non-obvious method, system and computer program product for progressive vendor data management and verification in a multi-node supply chain. In one embodiment of the invention, a method for progressive vendor data management and verification in a multi-node supply chain can be provided. The method can include propagating vendor data requirements for a product component downstream from a root node in the supply chain to a leaf node in the supply chain producing a portion of the product component. The method further can include verifying vendor data at each node in the supply chain according to the vendor data requirements.

In one aspect of the embodiment, propagating vendor data requirements for a product component downstream from a root node in the supply chain to a leaf node in the supply chain producing a portion of the product component can include recursively constructing a set of vendor data requirements from a upstream nodes in the supply chain at each point of verification in the supply chain. In another aspect of the embodiment, verifying vendor data at each node in the supply chain according to the vendor data requirements can include comparing at each node in the supply chain received vendor data with the vendor data requirements to ensure completeness.

In another embodiment of the invention, a progressive vendor data management and verification data processing system for a supply chain can be provided. The system can include the shipping and receiving function of a manufacturing system coupled with manufacturing execution systems. The system further can include verification logic coupled to the manufacturing execution system. The verification logic can include program code enabled to verify both downstream vendor data received from a downstream node in the supply chain against downstream requirements for the manufacturing execution system, and upstream vendor data generated in the manufacturing execution system against upstream vendor data requirements retrieved from an upstream node in the supply chain. Notably, in one aspect of the embodiment, the verification logic can include a recursive call to retrieve the upstream vendor data requirements.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a multi-node supply chain configured for progressive vendor data management and verification;

FIG. 2 is a schematic illustration of a progressive vendor data management and verification data processing system configured for a node within the multi-node supply chain of FIG. 1;

FIG. 3 is a flow chart illustrating a process for progressive vendor data management and verification in the multi-node supply chain of FIG. 1; and,

FIG. 4 is a tabular illustration of a rule structure configured for a node within the multi-node supply chain of FIG. 1.

### DETAILED DESCRIPTION OF THE INVENTION

Embodiments of the present invention provide a method, system and computer program product for progressive vendor data management and verification in the multi-node supply chain. In accordance with an embodiment of the present invention, the vendor data requirements for a product component for each customer node in a multi-node supply chain can propagate downstream from node to node to a leaf supplier node. The receipt and verification of vendor data corresponding to the vendor data requirements, in turn, can propagate upstream from node to node in the multi-node supply chain to a root customer node. In this way, vendor data requirements for the multi-node supply chain can be dynamically managed in real-time for downstream nodes and vendor data produced at all tiers of the multi-node supply chain can be shared with all upstream nodes.

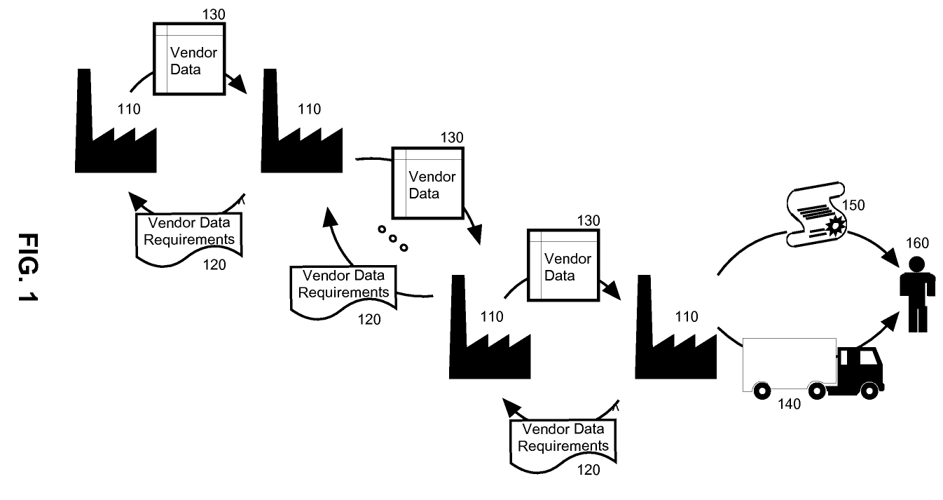

In illustration, FIG. 1 pictorially depicts a multi-node supply chain configured for progressive vendor data management and verification. In the multi-node supply chain of FIG. 1, multiple different nodes 110 can be provided, each node 110 representing at least one of a supplier or a customer in the multi-node supply chain. Each upstream one of the nodes 110 can publish its vendor data requirements 120 to a communicatively coupled downstream one of the nodes 110. Correspondingly, nodes 110 representing suppliers can provide vendor data 130 to a communicatively coupled upstream one of the nodes 110. As each of the nodes 110 representing a supplier ships component parts upstream to a node 110 representing a customer, the vendor data requirements 120 for the node 110 representing the customer can be retrieved and fulfilled with vendor data 130.

Upon receiving vendor data 130, a customer one of the nodes 110 can verify the vendor data 130 according to its own vendor data requirements 120. The customer one of the nodes 110 in turn, acting as a supplier, can forward its own vendor data 130 to an upstream customer one of then nodes 110 according to vendor data requirements 120 for the upstream customer one of the nodes 110. The process can continue until a root one of the upstream nodes 110 ships a finished product 140 to customer 160 along with comprehensive vendor data 150 accounting for the vendor data 130 received throughout the supply chain.

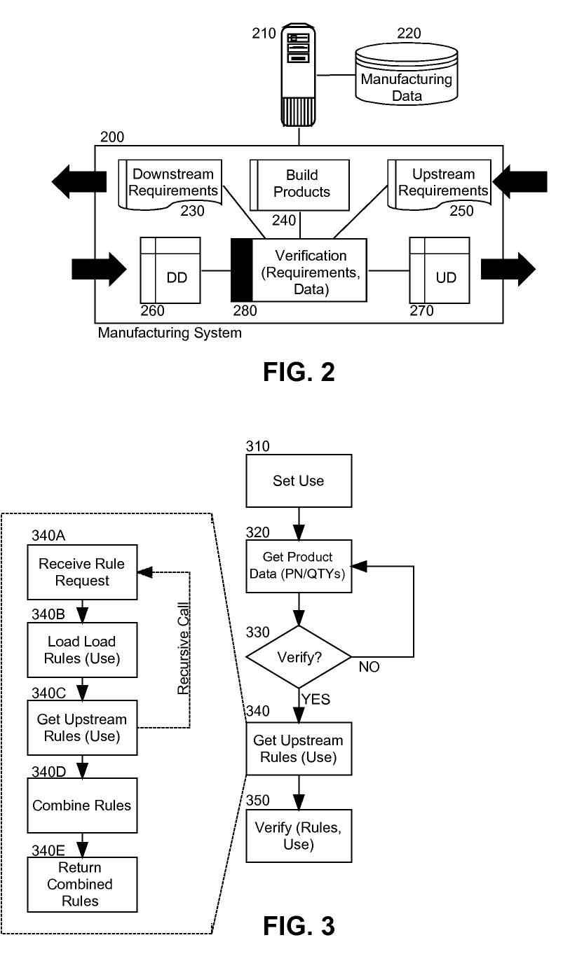

Each of the nodes 110 can support a progressive vendor data management and verification data processing system. In illustration, FIG. 2 depicts a progressive vendor data management and verification data processing system configured for a node within the multi-node supply chain of FIG. 1. The system can include a host computing platform 210 coupled to a repository of manufacturing data 220. Of note, the host computing platform 210 can be supplanted by a distributed configuration in which different vendor in a supply chain can supply a host computing platform communicatively coupled to the host computing platforms of other vendors in the supply chain. The host computing platform 210 can support the operation of a manufacturing system 200. The manufacturing system 200 can include a manufacturing execution system 240 configured to manage the building of products from components in inventory received from downstream suppliers. The manufacturing execution system 240 further can be configured to manage the shipment of built products to upstream customers as components in a larger assembly.

Notably, verification logic 280 can be coupled to the manufacturing execution system 240. The verification logic 280 can include program code enabled not only to publish the downstream requirements 230 for components supplied by downstream suppliers, but also to retrieve the upstream requirements 250 for the products to be produced by the manufacturing execution system 240. The program code of the verification logic 280 yet further can be enabled to compare received downstream vendor data 260 to the downstream requirements 230 to ensure compliance. Likewise, the program code of the verification logic 280 can be enabled to assemble and compare upstream vender data 270 to the upstream requirements 250 before forwarding the upstream vendor data 270 to an upstream customer along with a shipment of associated products.

Importantly, each node in the supply chain can apply the verification logic 280 to ensure the integrity of upstream vendor data 270 provided to an upstream customer. Similarly, each node in the supply chain can apply the verification logic 280 to ensure the integrity of downstream vendor data 260 received from a downstream supplier. Finally, changes to the upstream requirements 250 automatically will be realized in the downstream vendor as it remains incumbent upon the downstream vendor to retrieve the upstream requirements at the time of verifying the upstream vendor data 270.

As shown in FIG. 2, the verification logic 280 can perform verification of both downstream vendor data 260 and upstream vendor data 270 according to the downstream requirements 230 and upstream requirements 250, respectively. In further illustration of the operation of the verification logic 280, FIG. 3 is a flow chart illustrating a process for progressive vendor data management and verification in the multi-node supply chain of FIG. 1. Beginning in block 310, a use for vendor data can be determined and in block 320, vendor data can be received for either inbound components from a downstream vendor for use in building a product, or outbound components for use in building a product upstream.

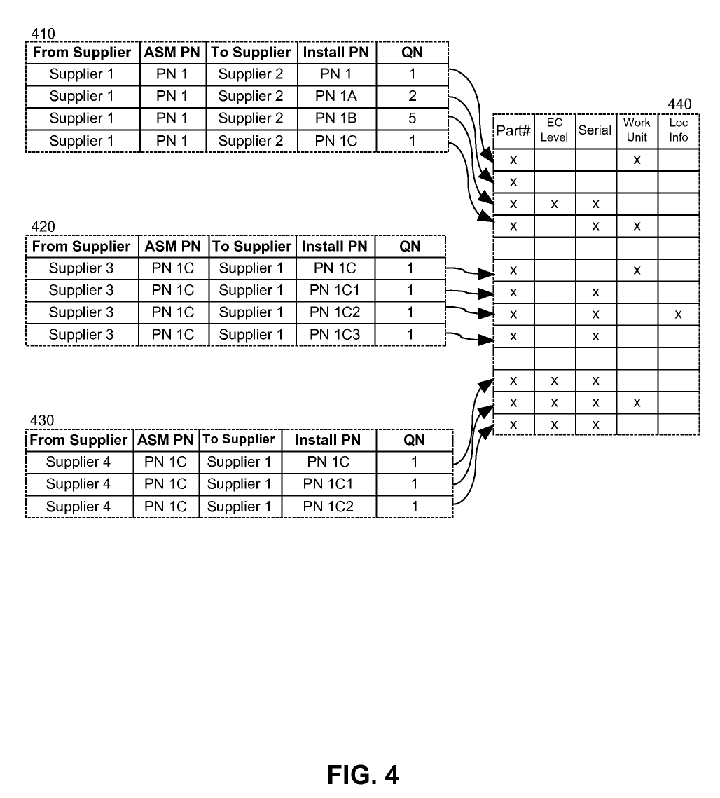

In decision block 330, it can be determined whether or not the vendor data is ripe for verification. For example, the vendor data can be ripe for verification in temporal proximity to shipping a corresponding product, or upon receiving inbound components from a vendor. If so, in block 340 upstream requirements can be retrieved from an upstream node in the supply chain recursively based upon the specified use. In particular, in block 340A, a rule request can be received from a downstream node for retrieving upstream requirements for vendor data. Exemplary rules returned in response to a rule request are shown in FIG. 4.

Specifically, the exemplary rules of FIG. 4 demonstrate a two level assembly where PN1 manufactured by Supplier 1 for the benefit of Supplier 2 includes PN 1C in its assembly. PN 1C in turn is manufactured by two different suppliers: Supplier 3 and Supplier 4 for the benefit of Supplier. Supplier Structure Rules 410 for Supplier 1 also indicate a correspondence with data collection parameters for each part in the assembly for PN 1. Likewise, Supplier Structure Rules 420, 430 for Supplier 2 and Supplier 3, respectively, indicate a correspondence with data collection parameters for each part in the assembly for PN 1C.

Returning to FIG. 3, In block 340B, the requirements in the upstream node can be retrieved and in block 340C, the requirements from a yet further upstream node can be requested based upon use. It will be recognized by the skilled artisan that the call for retrieving upstream rules is a recursive call that will nest until reaching a root node lacking an upstream node. Only at that time will the recursive quest for upstream rules unwind. At each downstream node during unwinding, in block 340D the retrieved vendor requirements can be combined with vendor requirements locally situated in the downstream node as retrieved in block 340B. Finally, in block 340E the combined vendor data requirements can be returned to the next downstream node until reaching a leaf node for the supply chain. Thereafter, in block 350, the set of recursively discovered vendor data requirements can be used to verify the vendor data.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for progressive vendor data management and verification in a multi-node supply chain, the method comprising:
propagating vendor data requirements for a product component downstream from a root node in the supply chain to a leaf node in the supply chain producing a portion of the product component; and,
verifying vendor data at each node in the supply chain according to the vendor data requirements.

2. The method of claim 1, wherein propagating vendor data requirements for a product component downstream from a root node in the supply chain to a leaf node in the supply chain producing a portion of the product component, comprises recursively constructing a set of vendor data requirements from a plurality of upstream nodes in the supply chain at each point of verification in the supply chain.

3. The method of claim 1, wherein verifying vendor data at each node in the supply chain according to the vendor data requirements, comprises comparing at each node in the supply chain received vendor data with the vendor data requirements to ensure completeness.

4. In a supply chain, a progressive vendor data management and verification data processing system comprising:
a manufacturing system;
a manufacturing execution system coupled to the manufacturing system; and,
verification logic coupled to the manufacturing execution system, the verification logic comprising program code enabled to verify both downstream vendor data received from a downstream node in the supply chain against downstream requirements for the manufacturing execution system, and upstream vendor data generated in the manufacturing execution system against upstream vendor data requirements retrieved from an upstream node in the supply chain.

5. The system of claim 4, wherein the verification logic comprises a recursive call to retrieve the upstream vendor data requirements.

6. A computer program product comprising a computer usable medium embodying computer usable program code for progressive vendor data management and verification in a multi-node supply chain, the computer program product comprising:
computer usable program code for propagating vendor data requirements for a product component downstream from a root node in the supply chain to a leaf node in the supply chain producing a portion of the product component; and,
computer usable program code for verifying vendor data at each node in the supply chain according to the vendor data requirements.

7. The computer program product of claim 6, wherein the computer usable program code for propagating vendor data requirements for a product component downstream from a root node in the supply chain to a leaf node in the supply chain producing a portion of the product component, comprises computer usable program code for recursively constructing a set of vendor data requirements from a plurality of upstream nodes in the supply chain at each point of verification in the supply chain.

8. The computer program product of claim 6, wherein the computer usable program code for verifying vendor data at each node in the supply chain according to the vendor data requirements, comprises computer usable program code for comparing at each node in the supply chain received vendor data with the vendor data requirements to ensure completeness.
